(19) United States
(12) Patent Application Publication
(10) Pub. No.: US 2011/0184542 A1
(43) Pub. Date: Jul. 28, 2011

(54) METHOD AND APPARATUS FOR GENERATING A SEQUENCE OF A PLURALITY OF IMAGES TO BE DISPLAYED WHILST ACCOMPANIED BY AUDIO

(75) Inventors: Tsvetomira K. Tsoneva, Eindhoven (NL); Marc Andre Peters, Eindhoven (NL); Pedro Fonseca, Eindhoven (NL)

(73) Assignee: Koninklijke Philips Electronics N.V.

(21) Appl. No.: 13/122,601

(22) PCT Filed: Sep. 28, 2009
(86) PCT No.: PCT/IB09/54234

§ 371 Date: Apr. 5, 2011

(30) Foreign Application Priority Data
Oct. 7, 2008 (EP) 08165964.1

(51) Int. Cl. G06F 17/00

(52) U.S. Cl. 700/94

(57) ABSTRACT

A sequence of a plurality of images to be displayed as a slide show whilst accompanied by an audio item is generated by extracting (209) at least one feature of an audio item, such as pace, —extracting (203) at least one feature of each of a plurality of images; and determining (215) the next image to generate a sequence of selected ones of the plurality of images to be displayed whilst accompanied by the audio item on the basis of the extracted at least one feature of the audio item and on the basis of the extracted at least one feature of the image.

### FIELD OF THE INVENTION

The present invention relates to method and apparatus for generating a sequence of a plurality of images. In particular it relates to method and apparatus for generating a sequence of a plurality of images to be displayed whilst accompanied by an audio item.

### BACKGROUND OF THE INVENTION

The price of the storage devices has significantly dropped in the last few years. As a result, users have collections of thousands of images (photographs) which are tedious and difficult to browse and view. This has resulted in an increasing demand for new and different ways to present such images.

Sharing memorable moments with friends and family has shifted from more traditional albums and photo frames to digital media, such as personal computers, television sets and digital photo frames which present their own difficulties. People tend to take a lot of similar pictures of the same objects so they can ensure that there will be one with the right lighting, colours and composition. However, with the low price of storage devices, they rarely seem to delete the redundant photos. So that, the former pleasurable activity of sharing memories with others now has turned into silent watching of endless monotonous slide shows.

There has, therefore, been an increasing demand for delivering more engaging presentations which combine music and photos allowing consumers to once again enjoy the experience of photo viewing alone or with family and friends.

Many systems have been developed to combine music and image presentation. In particular, changing the images according to the beat of the music as disclosed, for example, by US20070101355. However, this system does not necessarily provide a visually pleasing display.

### SUMMARY OF THE INVENTION

The present invention seeks to provide a display of images which is visually more pleasurable.

This is achieved according to a first aspect by a method of generating a sequence of a plurality of images to be displayed whilst accompanied by an audio item, the method comprising the steps of: extracting at least one feature of an audio item; extracting at least one feature of each of a plurality of images; and determining the next image to generate a sequence of selected ones of the plurality of images to be displayed whilst accompanied by the audio item on the basis of the extracted at least one feature of the audio item and on the basis of the extracted at least one feature of the image.

This is also achieved by a second aspect by apparatus for generating a sequence of a plurality of images to be displayed whilst accompanied by an audio item, the apparatus comprising: a first extractor for extracting at least one feature of an audio item; a second extractor for extracting at least one feature of each of a plurality of images; a processor for determining the next image to generate a sequence of selected ones of the plurality of images to be displayed whilst accompanied by the audio item on the basis of the extracted at least one feature of the audio item and on the basis of the extracted at least one feature of the image.

In this way, both characteristics of the audio and content of each image are taken into account to generate the sequence of images to be displayed whilst accompanied by the audio items, providing a more pleasurable viewing experience.

Further, the duration of display of each image of the sequence of the selected set of the plurality of images (304_1 to 304_{—}n, 306_1, 306_{—}n) may be determined on the basis of the extracted at least one feature of the audio.

In an embodiment a slideshow may be created according to the pace of music. The choice of photo view time and/or which photo to display next is carried out based on a combination of a numerical measure of music pace and a numerical representation of the distance or similarity between photos and/or groups of photos. For example, in the case of fast paced music, images may be chosen to be very different from each other while if the music is slow, images may be chosen to be similar. As a result, very similar images are clustered to present smoother transitions of the images which may also be displayed longer to compliment slow-paced music and, further, present a sequence of dissimilar images at a faster pace of music. Consequently, a natural flow of view of the images is created that follows the music rhythm.

### BRIEF DESCRIPTION OF DRAWINGS

For a more complete understanding of the present invention, reference is made to the following description in conjunction with the accompanying drawings, in which:

FIG. 1 is a simplified schematic of apparatus according to an embodiment of the present invention;

FIG. 2 is a flowchart of the method according to an embodiment of the present invention; and

FIG. 3 illustrates examples of presentations of images created by the embodiment of the present invention.

### DETAILED DESCRIPTION OF AN EMBODIMENT OF THE INVENTION

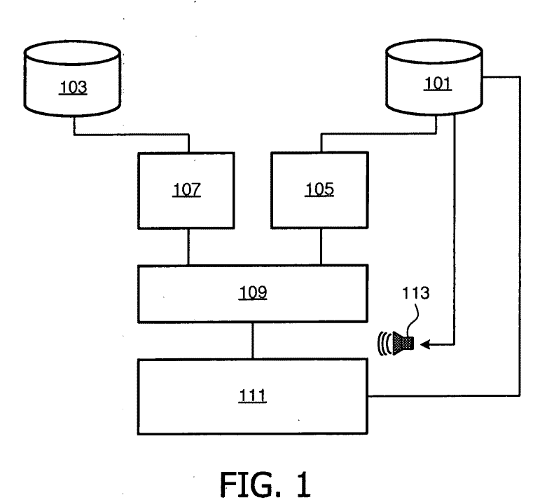

With reference to FIGS. 1 to 3, an embodiment of the present invention will be described.

The apparatus of the embodiment of the present invention is shown in FIG. 1. The apparatus comprises a first storage device 101 for storing a library of audio items. This may be a local storage device of a personal computer or PDAs or CD ROM, memory card, flash memory, or remote storage accessed over the internet. The apparatus also comprises a second storage device 103 for storing a library of digital images (photographs). This may be local storage device of a personal computer, digital camera, mobile phone or similar device, CD ROM, memory cards, flash memory or remote storage accessed over the internet. The first and second storage devices 101, 103 may be integrated.

The first storage device 101 is connected to a first extractor 105. The second storage device 103 is connected to a second extractor 107. The outputs of the first and second extractors 105, 107 are connected to respective inputs of a processor 109. The output of the processor is connected to a display 111 such as a computer monitor, display of a handheld device, projector screen, television, digital photo frame etc. The first storage device 101 is connected to a loudspeaker 113.

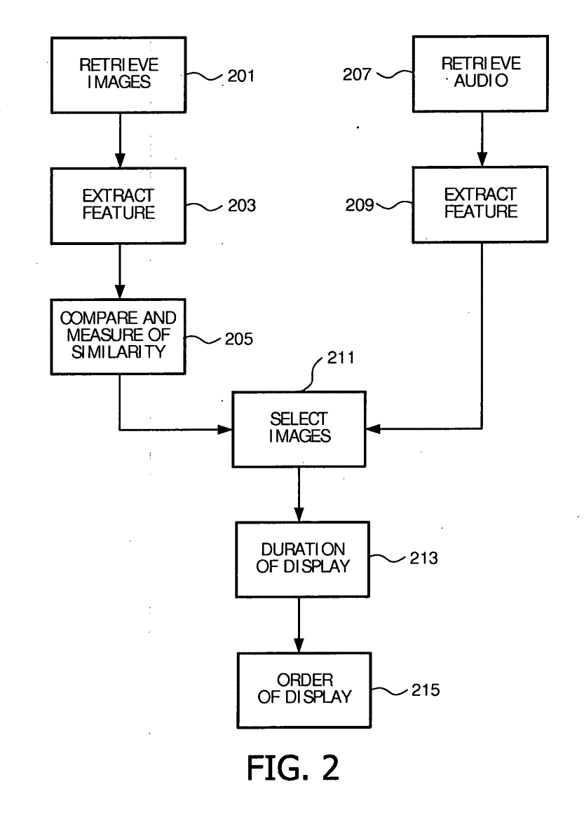

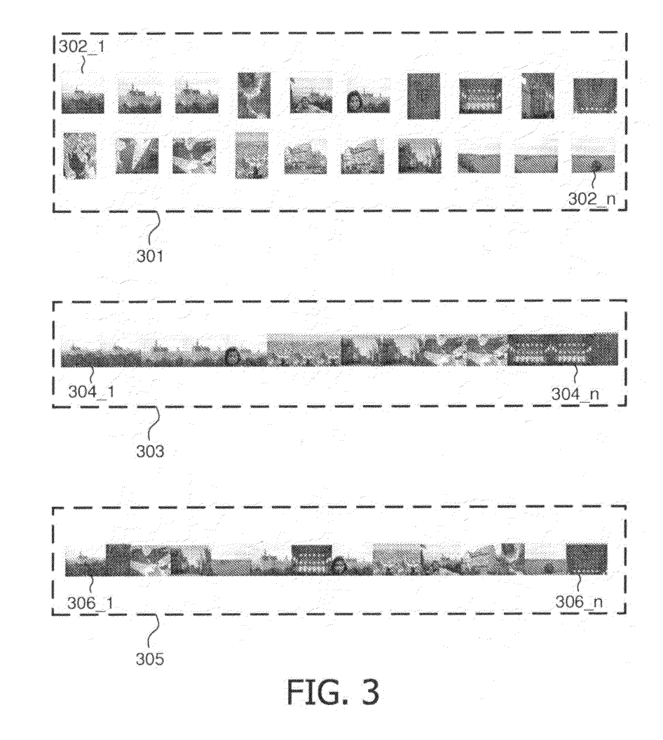

Operation of the apparatus of FIG. 1 will now be described with reference to FIGS. 2 and 3. A plurality 301 of images 302_1 to 302_{—}n are retrieved from the second storage devices 103, step 201. This may be selected by the user as a collection of images taken at a particular event, for example, or may be all images that the user has in their collection. An audio item is retrieved from the first storage device 101, step 207. This may be selected by the user or selected at random. The audio item may comprise a single music track or a playlist of a plurality of music tracks.

The first extractor 105 extracts at least one feature from the retrieved audio item, step 209, such as tempo (number of beats per minute), rhythm (beat's structure), rhythm change or melody, for example to determine the pace of the audio item.

The second extractor 107 extracts at least one feature from the retrieved images, step, 203, such as colour, texture, capture time, capture date, capture location, presence and identity of faces using known facial recognition techniques. A distance measure between each image is computed, step 205. This distance measure is a measure of the similarity and reflects how similar or related images are and can be based on one or a combination of the extracted feature(s).

A set (303, 305) of a plurality of images (304_1 to 304_{—}n, 306_1 to 306_{—}n) is then selected, step 211, on the basis of the extracted features of the audio item and the images. This may, of course, result in all the images being selected.

During the display of a sequence of the retrieved images, for example, during a slideshow (or when preparing a slideshow offline), for each image, the duration of display of each image is determined and which image to show next in the sequence is determined by the processor 109, steps 213, 215.

The display duration of each image is determined as to the amount of time the image is shown on the screen and is short for a fast pace audio item and longer for slow paced audio item.

In order to determine the next image within the sequence to be shown, images that are significantly different (dissimilar—e.g., within a large distance) 306_1 to 306_{—}n are selected for fast paced music e.g. the extracted pace is above a threshold, as shown, for example, in the group 305 of FIG. 3. Images that are similar—e.g., within a small distance 304_1 to 304_{—}n are chosen in the case of slow paced music e.g. the extracted pace is below a threshold, as shown in group 303 of FIG. 3. Therefore, the image content and the audio content are taken into account in compiling the sequence of images to be displayed when accompanied by audio. As a result a dynamic fast paced music photo presentation or a smooth slow paced music photo presentation which follows the natural flow of the music is obtained.

In addition to the basic system, different transitions can be used within the slideshow. For example, when the music is fast paced, abrupt transitions between two photos can be used. If the music is slow-paced, slow dissolves between photos can be used instead.

A further embodiment can include predefined mood sets (e.g. happy, relaxing, emotional, festive, etc.) where both the music and the images are trying to convey a certain mood. For example classical music and landscape pictures can be in a relaxing set, while jazz and pictures with a lot of faces and can be in an emotional set.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method of generating a sequence (303, 305) of a plurality of images (304_1 to 304_{—}n, 306_1 to 306_{—}n) to be displayed whilst accompanied by an audio item, the method comprising the steps of:
extracting (209) at least one feature of an audio item;
extracting (203) at least one feature of each of a plurality of images (302_1 to 302_{—}n); and
determining (215) the next image to generate a sequence (303, 305) of selected ones of said plurality of images (304_1 to 304_{—}n, 306_1 to 306_{—}n) to be displayed whilst accompanied by said audio item on the basis of said extracted at least one feature of said audio item and on the basis of said extracted at least one feature of said images (302_1 to 302_{—}n).

2. A method according to claim 1, wherein the method further comprises the step of determining (213) the duration of display of each image (304_1 to 304_{—}n, 306_1 to 306_{—}n) of said sequence (303, 305) of said selected ones of said plurality of images (304_1 to 304_{—}n, 306_1 to 306_{—}n) on the basis of said extracted at least one feature of said audio item.

3. A method according to claim 2, wherein the duration of display of each image (304_1 to 304_{—}n, 306_1 to 306_{—}n) of said sequence (303, 305) of said selected ones of said plurality of images corresponds to an extracted pace of said audio item.

4. A method according to claim 1, wherein the step of extracting (209) at least one feature of an audio item comprises the step of:
extracting the pace of said audio item.

5. A method according to claim 4, wherein the step of determining (215) the next image comprises the step of:
determining the next image on the basis of said extracted pace of said audio item and on the basis of the degree of similarity between said extracted at least one feature of said selected ones of said images (304_1 to 304_{—}n, 306_1 to 306_{—}n).

6. A method according to claim 4, wherein the method further comprises:
comparing (205) said extracted at least one feature of each of a plurality of images (304_1 to 304_{—}n, 306_1 to 306_{—}n) to determine the similarity between each of the images (304_1 to 304_{—}n, 306_1 to 306_{—}n).

7. A method according to claim 6, wherein the step of comparing (205) said extracted at least one feature of each of a plurality of images comprises the step of:
measuring the distance between said extracted at least one feature of each of said plurality of images (304_1 to 304_{—}n, 306_1 to 306_{—}n).

8. A computer program product comprising a plurality of program code portions for carrying out the method according to claim 1.

9. Apparatus for generating a sequence (303, 305) of a plurality of images (304_1 to 304_{—}n, 306_1 to 306_{—}n) to be displayed whilst accompanied by an audio item, the apparatus comprising:
a first extractor (105) for extracting (209) at least one feature of an audio item;
a second extractor (107) for extracting (203) at least one feature of each of a plurality of images (302_1 to 302_{—}n);
a processor (109) for determining (215) the next image to generate a sequence (303, 305) of selected ones of said plurality of images (304_1 to 304_{—}n, 306_1 to 306_{—}n) to be displayed whilst accompanied by said audio item on the basis of said extracted at least one feature of said audio item and on the basis of said extracted at least one feature of said image.

10. Apparatus according to claim 9, wherein said processor (109) determines the duration of display of each image (304_1 to 304n, 306_1 to 306_{—}n) of said sequence (303, 305) of said selected ones of said plurality of images (304_1 to 304_{—}n, 306_1 to 306_{—}n) on the basis of said extracted at least one feature of said audio item.
